(19) United States
(12) Patent Application Publication
(10) Pub. No.: US 2024/0017403 A1
(43) Pub. Date: Jan. 18, 2024

(54) ROBOT CONTROL SYSTEM, ROBOT CONTROL METHOD, AND ROBOT

(71) Applicant: ABB Schweiz AG, Baden (CH)

(72) Inventors: Zhuan Yu, Shanghai (CN); Bojun Ma, Shanghai (CN)

(21) Appl. No.: 18/254,776

(22) PCT Filed: Dec. 11, 2020
(86) PCT No.: PCT/CN2020/135854

§ 371 Date: May 26, 2023

(51) Int. Cl. B25J 9/16

(52) U.S. Cl. CPC B25J 9/1628

(57) ABSTRACT

A robot control system, a robot control method, and a robot. The robot control system includes a motion control unit configured to perform motion control of a robot, and a rectifier control unit which includes an AC-DC control unit configured to generate a rectifier control signal for driving a rectifier power stage. The rectifier power stage is bcing configured to convert AC power from a grid into DC power. The robot control system also includes a safety control unit configured to generate a safety control signal for selectively turning on or off safety switches connected to an output of the rectifier power stage. The robot control system also includes a motor control unit configured to perform motor control of the robot.

### FIELD

Example embodiments of the present disclosure generally relate to the field of robot control, and more specifically, to a robot control system, a robot control method, and a robot.

### BACKGROUND

A robot control system is a device that controls a robot to complete certain actions or tasks according to instructions and sensor information. The robot control system is the heart of the robot and determines the performance of the robot.

FIG. 1 illustrates a block diagram of a conventional robot control system. As shown in FIG. 1, the robot control system 100 generally includes a motion controller 101 for performing motion control of the robot, a safety controller 102 for performing safety control of the robot, a rectifier 103 for converting AC power to DC power, and a motor driver 104 for performing motor control of the robot. Traditionally, the motion controller 101, the safety controller 102, and the motor driver 104 have a large amount of calculation units so as to perform the corresponding control. In contrast, the conventional rectifier 103 is typically formed by passive devices, such as diodes, and barely requires calculation units.

With the development of more advanced power semiconductor devices like SiC and GaN with switching loss lower than silicon based semiconductor devices, active rectifier control becomes more and more feasible in the robot control system. The active rectifier control requires calculation units. Furthermore, with the increasing of control and switching frequency of the rectifier 103, calculation units having higher performance would be necessary in the active rectifier control. Typical solution for the active rectifier control is making a separate rectifier control unit with an MCU/DSP/DSC to implement such a control function.

However, the conventional solution of the active rectifier control has several drawbacks. First, the calculation power of the MCU/DSP/DSC in the separate rectifier control unit is limited, decreasing the performance of the robot control system 100. Second, for the purpose of supervision, there might be extra wired communication links and/or IO (input/output) links between the motion controller 101 and the separate rectifier control unit, which would cause the structure of the robot control system 100 to be complicated and of high cost. Third, the safety controller 102 should have the ability of cutting off power source of the robot in case of emergency or other situations, which requires interaction between the safety controller 102 and the separate rectifier control unit. Such an interaction now is achieved by using discrete IO terminals with low communication speed. Fourth, since the control of DC bus in the robot control system 100 is based on the feedback, the control performance of the separate rectifier control unit would be low, which would result in high voltage fluctuation on the DC buss.

Thus, there is a need for an improved solution for robot control.

### SUMMARY

In view of the foregoing problems, example embodiments of the present disclosure provide solutions for robot control in a manner that is high efficient, low cost, and reliable.

In a first aspect, example embodiments of the present disclosure provide a robot control system comprising: a motion control unit configured to perform motion control of a robot; a rectifier control unit comprising an AC-DC control unit configured to generate a rectifier control signal for driving a rectifier power stage, the rectifier power stage being configured to convert AC power from a grid into DC power; a safety control unit configured to generate, based on an operating state of the robot or a user input, a safety control signal for selectively turning on or off safety switches connected to an output of the rectifier power stage; and a motor control unit configured to perform motor control of the robot based on the DC power received via the safety switches, wherein the motion control unit, the rectifier control unit, and the safety control unit are integrated in a same chip.

According to embodiments of the present disclosure, the motion control unit, the rectifier control unit, and the safety control unit integrated in the same chip would use an on-chip data bus for supervision, removing wired communication links and/or IO links between the rectifier control unit and other control units. In this way, the performance of the robot control system could be improved and the cost of the robot control system could be reduced. Moreover, since the calculation ability of the chip with the motion control unit, the rectifier control unit, and the safety control unit integrated thereon is much higher than the MCU/DSP/DSC, a higher switching frequency could be supported in the rectifier control unit. Further, the integration of the motion control unit, the rectifier control unit, and the safety control unit in the same chip would reduce the overall size of the robot control system and save spaces in the robot.

In some embodiments, the motion control unit, the rectifier control unit, the safety control unit, and the motor control unit are integrated in the same chip. With these embodiments, the integration of the motor control unit in the same chip would further reduce the overall size of the robot control system and save spaces in the robot.

In some embodiments, the robot control system further comprises a cache disposed on the same chip and coupled to the motion control unit, the rectifier control unit, and the safety control unit, wherein the motion control unit, the rectifier control unit, and the safety control unit perform data transmission via the cache. With these embodiments, various information could be interchanged between the rectifier control unit and other control units via the cache in a manner that is high speed and reliable.

In some embodiments, the AC-DC control unit is further configured to receive a power consumption prediction signal from the motion control unit and adjust the rectifier control signal based on the power consumption prediction signal. With these embodiments, the AC-DC control unit may adjust the rectifier control signal based on the power consumption prediction signal dynamically so as to prepare appropriate amount of power for the robot in advance. In this way, the fluctuation of the voltage outputted by the rectifier power stage could be lowered.

In some embodiments, the rectifier control unit further comprises a grid supervision unit configured to monitor the quality of the grid and send the information representing the quality of the grid to the motion control unit. With these embodiments, the quality of the grid could be monitored in real time for further use.

In some embodiments, the grid quality comprises at least one of voltage dip, voltage distortion, and voltage fluctuation.

In some embodiments, the rectifier control unit further comprises a power stage supervision unit configured to monitor an operating condition of the rectifier power stage and send the information representing operating condition of the rectifier power stage to the motion control unit. With these embodiments, the operating condition of the rectifier power stage could be monitored in real time so as to perform predictive maintenance.

In some embodiments, the rectifier control unit further comprises a DC-AC control unit configured to convert the DC power into single-phase AC power for on-site use.

In some embodiments, the safety control unit is configured to turn off the safety switches in response to at least one of: a critical error being occurred in the grid or in the rectifier power stage; a moving speed of the robot exceeding a predefined speed threshold; the robot exceeding a predefined position range; and the user input being an emergency stop signal. With these embodiments, the safety switches may be turned off timely when an emergency occurs in the robot or in response to the input of the user.

In a second aspect, example embodiments of the present disclosure provide a robot comprising the robot control system according to the first aspect of the present disclosure.

In a third aspect, example embodiments of the present disclosure provide a robot control method comprising: performing, by a motion control unit, motion control of a robot; generating, by an AC-DC control unit of a rectifier control unit, a rectifier control signal for driving a rectifier power stage, the rectifier power stage being configured to convert AC power from a grid into DC power; generating, by a safety control unit, based on an operating state of the robot or a user input, a safety control signal for selectively turning on or off safety switches connected to an output of the rectifier power stage; and performing, by a motor control unit, motor control of the robot based on the DC power received via the safety switches, wherein the motion control unit, the rectifier control unit, and the safety control unit are integrated in a same chip.

In some embodiments, the method further comprises: receiving, by the AC-DC control unit, a power consumption prediction signal from the motion control unit; and adjusting, by the AC-DC control unit, the rectifier control signal based on the power consumption prediction signal.

In some embodiments, the method further comprises: monitoring, by a grid supervision unit of the rectifier control unit, the quality of the grid; and sending, by the grid supervision unit, the information representing the quality of the grid to the motion control unit.

In some embodiments, the method further comprises: monitoring, by a power stage supervision unit of the rectifier control unit, an operating condition of the rectifier power stage; and sending, by the power stage supervision unit, the information representing operating condition of the rectifier power stage to the motion control unit.

In some embodiments, the safety control unit is configured to turn off the safety switches in response to at least one of: a critical error being occurred in the grid or in the rectifier power stage; a moving speed of the robot exceeding a predefined speed threshold; the robot exceeding a predefined position range; and the user input being an emergency stop signal.

### DESCRIPTION OF DRAWINGS

Drawings described herein are provided to further explain the present disclosure and constitute a part of the present disclosure. The example embodiments of the disclosure and the explanation thereof are used to explain the present disclosure, rather than to limit the present disclosure improperly.

FIG. 1 illustrates a block diagram of a conventional robot control system;

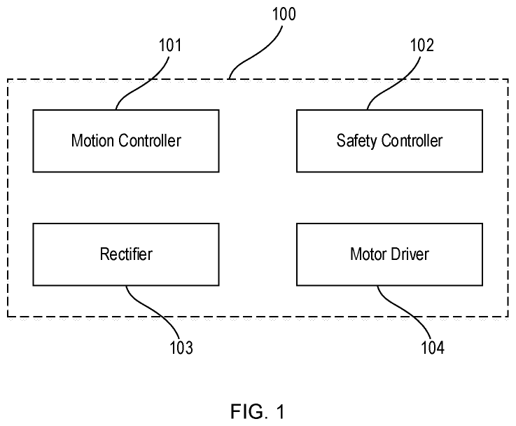

FIG. 2 illustrates a block diagram of a robot control system in accordance with an embodiment of the present disclosure;

FIG. 3 illustrates a block diagram of a rectifier control unit in accordance with an embodiment of the present disclosure;

FIG. 4 illustrates a block diagram of a robot control system in accordance with

another embodiment of the present disclosure; and

FIG. 5 illustrates a flowchart of a robot control method in accordance with embodiments of the present disclosure.

Throughout the drawings, the same or similar reference symbols are used to indicate the same or similar elements.

### DETAILED DESCRIPTION OF EMBODIEMTNS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

As discussed above, the conventional solution of the active rectifier control has several drawbacks. According to embodiments of the present disclosure, the motion control unit, the rectifier control unit, and the safety control unit integrated in the same chip would use an on-chip data bus for supervision, removing wired communication links and/or IO links between the rectifier control unit and other control units. The above idea may be implemented in various manners, as will be described in detail in the following paragraphs.

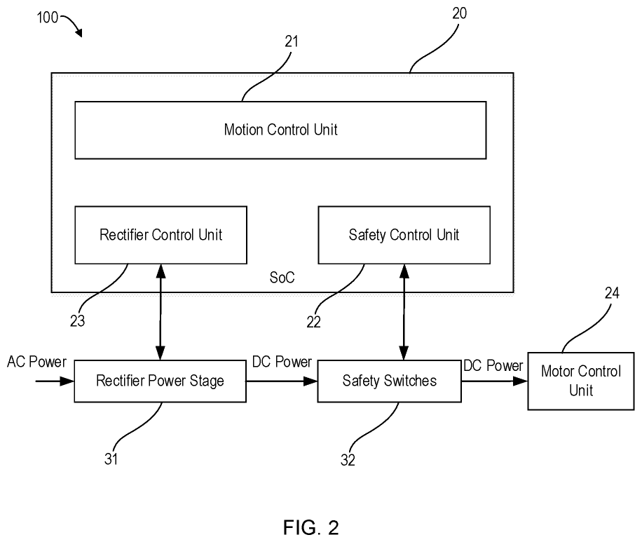

Hereinafter, the principles of the present disclosure will be described in detail with reference to FIGS. 2-5. Referring to FIG. 2 first, FIG. 2 illustrates a block diagram of a robot control system in accordance with an embodiment of the present disclosure. As shown, the robot control system 100 described herein generally includes a motion control unit 21, a rectifier control unit 23, a safety control unit 22, a motor control unit 24, a rectifier power stage 31, and safety switches 32.

The motion control unit 21 is configured to perform motion control of a robot. The motion control refers to computing target movements of the robot at every moment, such as one or more of the position, the speed, the acceleration, the force and the moment of force of the robot. The rectifier control unit 23 is configured to generate a rectifier control signal for driving the rectifier power stage 31 to convert AC power from a grid into DC power. The rectifier power stage 31 may include various power electronic devices controlled by the rectifier control signal, such as MOSFET, IGBT, and the like. The safety control unit 22 is configured to generate, based on an operating state of the robot or a user input, a safety control signal for selectively turning on or off the safety switches 32 connected to an output of the rectifier power stage 31. When the safety switches 32 are turned on, the transmission of the DC power is permitted, and when the safety switches 32 are turned off, the transmission of the DC power is cut off. The motor control unit 24 is configured to perform motor control of the robot based on the DC power received via the safety switches 32. The motor control unit 24 is connected to the safety switches 32 to receive the DC power and drive motors arranged at joints of the robot. The motion control unit 21, the rectifier control unit 23, and the safety control unit 22 are integrated in a same chip 20, such as System on Chip (SoC).

In some embodiments, the robot control system 100 further comprises a cache disposed on the chip 20 and coupled to the motion control unit 21, the rectifier control unit 23, and the safety control unit 22. With such an arrangement, the motion control unit 21, the rectifier control unit 23, and the safety control unit 22 may perform data transmission via the cache, such that various information could be interchanged between the rectifier control unit 23 and other control units via the cache in a manner that is high speed and reliable.

In some embodiments, the rectifier control unit 23 is further configured to receive a power consumption prediction signal from the motion control unit 21 and adjust the rectifier control signal based on the power consumption prediction signal. With these embodiments, the rectifier control unit 23 may adjust the rectifier control signal based on the power consumption prediction signal dynamically so as to prepare appropriate amount of power for the robot in advance. In this way, the fluctuation of the voltage outputted by the rectifier power stage 31 could be lowered.

Since the motion control unit 21, the rectifier control unit23, and the safety control unit 22 integrated in the chip 20 would use an on-chip data bus for supervision, wired communication links and/or IO links between the rectifier control unit 23 and other control units could be removed. In this way, the performance of the robot control system 100 could be improved and the cost of the robot control system 100 could be reduced. Moreover, since the calculation ability of the chip 20 with the motion control unit 21, the rectifier control unit 23, and the safety control unit 22 integrated thereon is much higher than the MCU/DSP/DSC, a higher switching frequency could be supported in the rectifier control unit 23. Further, the integration of the motion control unit 21, the rectifier control unit 23, and the safety control unit 22 in the same chip 20 would reduce the overall size of the robot control system 100 and save spaces in the robot.

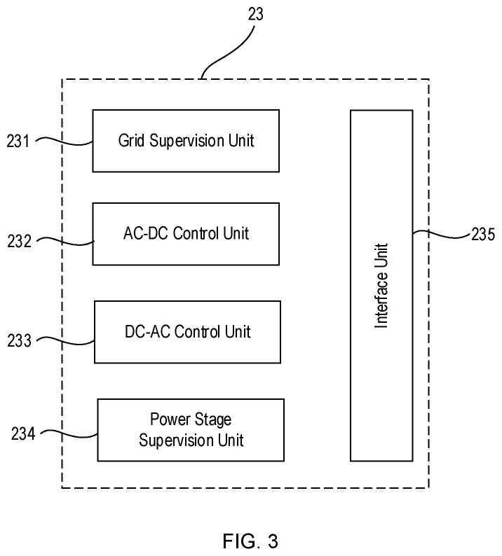

FIG. 3 illustrates a block diagram of a rectifier control unit in accordance with an embodiment of the present disclosure. In an embodiment, as shown in FIG. 3, the rectifier control unit 23 includes an AC-DC control unit 232 configured to generate the rectifier control signal for driving the rectifier power stage 31. The AC-DC control unit 232 may be further configured to receive the power consumption prediction signal from the motion control unit 21 and adjust the rectifier control signal based on the power consumption prediction signal. The rectifier control unit 23 may interchange information with other control units via an interface unit 235.

In some embodiments, as shown in FIG. 3, the rectifier control unit 23 further includes a grid supervision unit 231 configured to monitor the quality of the grid and send the information representing the quality of the grid to the motion control unit 21. With these embodiments, the quality of the grid could be monitored in real time for further use. The grid quality may include at least one of voltage dip, voltage distortion, and voltage fluctuation. However, it is to be understood that the grid quality may be of other types in other embodiments. The scope of the present disclosure is not intended to be limited in this respect.

In some embodiments, as shown in FIG. 3, the rectifier control unit 23 further includes a power stage supervision unit 234 configured to monitor an operating condition of the rectifier power stage 31 and send the information representing operating condition of the rectifier power stage 31 to the motion control unit 21. With these embodiments, the operating condition of the rectifier power stage 31 could be monitored in real time so as to perform predictive maintenance.

In some embodiments, as shown in FIG. 3, the rectifier control unit 23 further comprises a DC-AC control unit 233 configured to convert the DC power into single-phase AC power for on-site use.

In some embodiments, the safety control unit 22 is configured to turn off the safety switches 32 in response to at least one of: a critical error being occurred in the grid or in the rectifier power stage 31; a moving speed of the robot exceeding a predefined speed threshold; the robot exceeding a predefined position range; and the user input being an emergency stop signal. With these embodiments, the safety switches 32 may be turned off timely when an emergency occurs in the robot or in response to the input of the user. For example, if the user finds that the robot has an emergency stop, the user may input a control signal to turn off the safety switch 32. If a fence around the robot is opened, the safety switch 32 would be turned off so as to ensure the safety of the user. If the robot moves too fast of beyond the predefined position range, the safety switch 32 would be turned off. Moreover, during the debugging process of the robot, the safety switch 32 may need to be turned off. Moreover, if a critical error is occurred in the grid or in the rectifier power stage 31, the rectifier power stage 31 would be turned off.

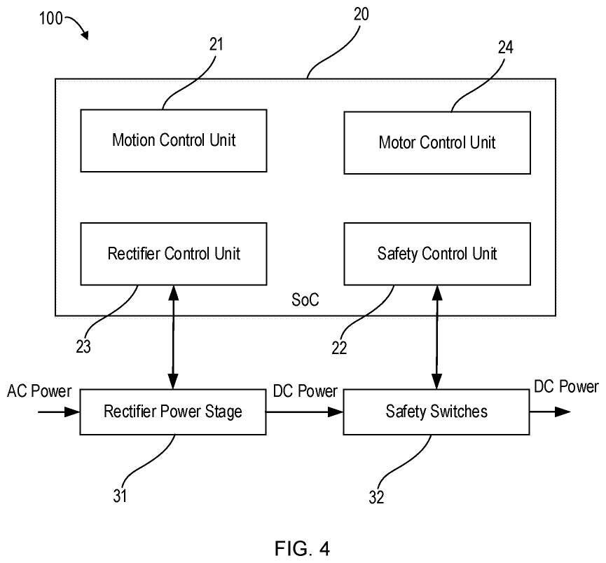

FIG. 4 illustrates a block diagram of a robot control system in accordance with another embodiment of the present disclosure. The construction of the robot control system 100 as shown in FIG. 4 is similar to that of the robot control system 100 as shown in FIG. 2. The difference between them merely lies in that the motor control unit 24 is also integrated in the chip 20 together with the motion control unit 21, the rectifier control unit 23, and the safety control unit 22. With such an arrangement, the overall size of the robot control system 100 could be further reduced.

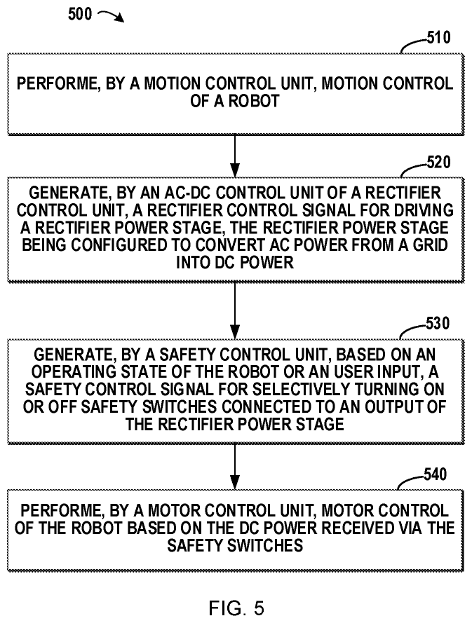

Example embodiments of the present disclosure also provide a robot control method 500, as shown in FIG. 5. The robot control method 500 may be implemented by the robot control system 100 as described above. As shown in FIG. 5, the robot control method 500 includes: at 510, performing, by the motion control unit 21, motion control of a robot; at 520, generating, by the AC-DC control unit 232 of the rectifier control unit 23, a rectifier control signal for driving a rectifier power stage 31, the rectifier power stage 31 being configured to convert AC power from a grid into DC power; at 530, generating, by the safety control unit 22, based on an operating state of the robot or a user input, a safety control signal for selectively turning on or off safety switches 32 connected to an output of the rectifier power stage 31; and at 540, performing, by the motor control unit 24, motor control of the robot based on the DC power received via the safety switches 32. The motion control unit 21, the rectifier control unit 23, and the safety control unit 22 are integrated in the same chip 20.

In some embodiments, the robot control method 500 further comprises: receiving, by the AC-DC control unit 232, a power consumption prediction signal from the motion control unit 21; and adjusting, by the AC-DC control unit 232, the rectifier control signal based on the power consumption prediction signal.

In some embodiments, the robot control method 500 further comprises: monitoring, by a grid supervision unit 231 of the rectifier control unit 23, the quality of the grid; and sending, by the grid supervision unit 231, the information representing the quality of the grid to the motion control unit 21.

In some embodiments, the robot control method 500 further comprises: monitoring, by a power stage supervision unit 234 of the rectifier control unit 23, an operating condition of the rectifier power stage 31; and sending, by the power stage supervision unit 234, the information representing operating condition of the rectifier power stage 31 to the motion control unit 21.

In some embodiments, the safety control unit 22 is configured to turn off the safety switches 32 in response to at least one of: a critical error being occurred in the grid or in the rectifier power stage 31; a moving speed of the robot exceeding a predefined speed threshold; the robot exceeding a predefined position range; and the user input being an emergency stop signal.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A robot control system comprising:
a motion control unit configured to perform motion control of a robot;
a rectifier control unit including:
an AC-DC control unit configured to generate a rectifier control signal for
driving a rectifier power stage,
the rectifier power stage being configured to convert AC power from a grid into DC power;
a safety control unit configured to generate, based on an operating state of the robot or a user input, a safety control signal for selectively turning on or off safety switches connected to an output of the rectifier power stage ; and
a motor control unit configured to perform motor control of the robot based on the DC power received via the safety switches,
wherein the motion control unit, the rectifier control unit, and the
safety control unit are integrated in a same chip.

2. The robot control system according to claim 1, wherein the motion control unit, the rectifier control unit, the safety control unit, and the motor control unit are integrated in the same chip.

3. The robot control system according to claim 1, further comprising a cache disposed on the same chip and coupled to the motion control unit, the rectifier control unit, and the safety control unit, wherein the motion control unit, the rectifier control unit, and the safety control unit perform data transmission via the cache.

4. The robot control system according to claim 1, wherein the AC-DC control unit is further configured to receive a power consumption prediction signal from the motion control unit and adjust the rectifier control signal based on the power consumption prediction signal.

5. The robot control system according to claim 1, wherein the rectifier control unit further comprises a grid supervision unit configured to monitor the quality of the grid and send the information representing the quality of the grid to the motion control unit.

6. The robot control system according to claim 5, wherein the grid quality comprises at least one of voltage dip, voltage distortion, and voltage fluctuation.

7. The robot control system according to claim 1, wherein the rectifier control unit further comprises a power stage supervision unit configured to monitor an operating condition of the rectifier power stage and send the information representing operating condition of the rectifier power stage to the motion control unit.

8. The robot control system according to claim 1, wherein the rectifier control unit further comprises a DC-AC control unit configured to convert the DC power into single-phase AC power for on-site use.

9. The robot control system according to claim 1, wherein the safety control unit is configured to turn off the safety switches in response to at least one of:
a critical error being occurred in the grid or in the rectifier power stage;
a moving speed of the robot exceeding a predefined speed threshold;
the robot exceeding a predefined position range; or
the user input being an emergency stop signal.

10. A robot comprising the robot control system according to claim 1.

11. A robot control method comprising:
performing, by a motion control unit, motion control of a robot;
generating, by an AC-DC control unit of a rectifier control unit, a rectifier control signal for driving a rectifier power stage, the rectifier power stage being configured to convert AC power from a grid into DC power;
generating, by a safety control unit, based on an operating state of the robot or a user input, a safety control signal for selectively turning on or off safety switches connected to an output of the rectifier power stage; and
performing, by a motor control unit, motor control of the robot based on the DC power received via the safety switches,
wherein the motion control unit, the rectifier control unit, and the safety control unit are integrated in a same chip.

12. The robot control method according to claim 11, further comprising:
receiving, by the AC-DC control unit, a power consumption prediction signal from the motion control unit; and
adjusting, by the AC-DC control unit, the rectifier control signal based on the power consumption prediction signal.

13. The robot control method according to claim 11, further comprising:
monitoring, by a grid supervision unitof the rectifier control unit, the quality of the grid; and
sending, by the grid supervision unit, the information representing the quality of the grid to the motion control unit.

14. The robot control method according to claim 11, further comprising:
monitoring, by a power stage supervision unit of the rectifier control unit, an operating condition of the rectifier power stage; and
sending, by the power stage supervision unit, the information representing operating condition of the rectifier power stage to the motion control unit.

15. The robot control method according to claim 1, wherein the safety control unit is configured to turn off the safety switches in response to at least one of:
a critical error being occurred in the grid or in the rectifier power stage;
a moving speed of the robot exceeding a predefined speed threshold;
the robot exceeding a predefined position range; or
the user input being an emergency stop signal.

16. The robot of claim 10, wherein the motion control unit, the rectifier control unit, the safety control unit, and the motor control unit are integrated in the same chip.

17. The robot of claim 10, wherein the robot control system further comprises a cache disposed on the same chip and coupled to the motion control unit, the rectifier control unit, and the safety control unit, wherein the motion control unit, the rectifier control unit, and the safety control unit perform data transmission via the cache.

18. The robot of claim 10, wherein the AC-DC control unit is further configured to receive a power consumption prediction signal from the motion control unit and adjust the rectifier control signal based on the power consumption prediction signal.

19. The robot of claim 10, wherein the rectifier control unit further comprises a grid supervision unit configured to monitor the quality of the grid and send the information representing the quality of the grid to the motion control unit.

20. The robot of claim 10, wherein the rectifier control unit further comprises a power stage supervision unit configured to monitor an operating condition of the rectifier power stage and send the information representing operating condition of the rectifier power stage to the motion control unit.
